(19) United States
(12) Patent Application Publication
(10) Pub. No.: US 2026/0296315 A1
(43) Pub. Date: Oct. 1, 2026

(54) ASSEMBLY WITH INTEGRATED LIGHT AND CAMERA

(71) Applicant: Rivian IP Holdings, LLC, Irvine, CA (US)

(72) Inventors: Saxon Pierce Aden, Orange, CA (US); Brandon L. Washington, Los Angeles, CA (US); David Martin Schneider, Oakfield, CA (US); Loren Edward Golden, Costa Mesa, CA (US)

(73) Assignee: Rivian IP Holdings, LLC, Irvine, CA (US)

(21) Appl. No.: 19/092,493

(22) Filed: Mar. 27, 2025

(51) Int. Cl. B60R 1/24; B60R 1/00; B60R 1/12; B60R 1/27; B60R 16/033

(52) U.S. Cl. CPC B60R 1/24; B60R 1/006; B60R 1/1207; B60R 1/27; B60R 2001/1253; B60R 16/033; B60Y 2200/91; B60Y 2304/072; B60Y 2304/076; B60Y 2410/10

(57) ABSTRACT

An assembly can include a housing and a sub-assembly. The housing can define a shape of the assembly. The sub-assembly can at least partially dispose within the housing. The sub-assembly can include a light source and a camera. The light source can indicate a status of a directional for the vehicle. The camera can assist with autonomous control of the vehicle.

### INTRODUCTION

Vehicles can include an assembly which houses a mirror or other reflective surface.

### SUMMARY

This disclosure is generally related to one or more components of a vehicle. The components can include at least one of assemblies, sub-assemblies, modules, systems, platforms, or components. For example, the vehicle can include an assembly which houses a mirror. As another example, the vehicle can include a sub-assembly which houses a light source and a camera. The assemblies or sub-assemblies can be located, placed, positioned, secured, mounted, coupled, or otherwise disposed on or within one or more portions of the vehicle. For example, a sub-assembly, which includes a light source and a camera, can be located on a side or lateral portion of the vehicle.

At least one aspect is directed to an assembly. The assembly can be for a vehicle. The assembly can include a housing. The housing can define a shape of the assembly. The assembly can include a sub-assembly. The sub-assembly can at least partially dispose within the housing. The sub-assembly can include a light source. The light source can indicate a status of a directional for the vehicle. The sub-assembly can include a camera. The camera can assist with autonomous control of the vehicle.

At least one aspect is directed to a vehicle. The vehicle can include an assembly. The assembly can include a housing. The housing can define a shape of the assembly. The assembly can include a sub-assembly. The sub-assembly can at least partially dispose within the housing. The sub-assembly can include a light source. The light source can indicate a status of a directional for the vehicle. The sub-assembly can include a camera. The camera can assist with autonomous control of the vehicle.

At least one aspect is directed to a sub-assembly. The sub-assembly can integrate with an assembly. The sub-assembly can at least partially dispose within a housing of the assembly. The sub-assembly can include a light source and a camera. The light source can be packaged with the camera. The light source can indicate a status of a directional for a vehicle. The camera can assist with autonomous control of the vehicle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a vehicle, in accordance with some aspects.

FIG. 2 depicts a perspective view of an assembly included in the vehicle illustrated in FIG. 1, in accordance with some aspects.

FIG. 3 depicts a perspective view of a sub-assembly included in the assembly illustrated in FIG. 2, in accordance with some aspects.

FIG. 4 depicts a perspective view of the sub-assembly illustrated in FIG. 3, in accordance with some aspects.

FIG. 5 depicts a cross-sectional view of the sub-assembly illustrated in FIG. 3, in accordance with some aspects.

FIG. 6 depicts a flow diagram of a process for a sub-assembly, in accordance with some aspects.

FIG. 7 is a block diagram illustrating an architecture for a computer system that can be employed to implement elements of the systems and methods described and illustrated herein, in accordance with some aspects.

### DETAILED DESCRIPTION

Following below are more detailed descriptions of various concepts related to, and implementations of, methods, apparatuses, and systems of assemblies or sub-assemblies for a vehicle. The various concepts introduced above and discussed in greater detail below may be implemented in any of numerous ways.

The present disclosure is directed to one or more components for a vehicle. The components can include one or more assemblies, systems, modules, elements, or components. For example, the vehicle can include a mirror assembly which houses one or more sub-assemblies. The sub-assemblies can be separate or otherwise discrete from the mirror assembly. For example, the sub-assemblies can be packaged or otherwise arranged separate from the mirror assembly. As another example, the sub-assemblies can include individual or distinguishable components to that of the mirror assembly.

Traditional mirror assemblies in vehicles have primarily served the purpose of providing visibility through reflective surfaces, often lacking integration with modern technologies. These mirror assemblies are limited in their ability to seamlessly incorporate advanced functionalities, such as cameras or light sources, without requiring additional components or structural modifications. Additionally, these mirror assemblies often include additional assembly to provide components such as light sources and cameras. The inclusion of additional assemblies leads to increased complexity, bulk, and potential interference between functionalities.

The disclosed solutions have a technical advantage of providing a mirror assembly that integrates a light source and a camera into a compact sub-assembly housed within the mirror assembly. The sub-assembly can partially reside within the housing, with distinct portions positioned externally and internally to optimize functionality and maintain the vehicle's aesthetic design. The light source can provide directional status indication, while the camera supports autonomous control by offering an unobstructed field of view. This integration aligns with providing autonomous vehicle features to enable a more cohesive design that supports advanced sensor and indicator systems without compromising the appearance of the vehicle or requiring extensive modifications.

The mirror assembly further provides a modular design that facilitates seamless replacement and compatibility with existing vehicle systems, which reduces maintenance complexity and ensures adaptability across various vehicle models. By combining these components into a unified structure, the mirror assembly achieves a streamlined design that eliminates the need for additional mounting structures, preserving the vehicle's appearance while advancing its technological capabilities. This design ensures that the camera's field of view remains unobstructed, enhancing its functionality for autonomous driving and safety features. Furthermore, the modularity of the sub-assembly simplifies maintenance and replacement, reducing associated costs and downtime.

The sub-assembly can interface with processing circuits, to enable communication with other vehicle systems, such as those managing autonomous driving or lighting controls. Furthermore, the sub-assembly can replace existing assemblies without modifying the housing, ensuring compatibility with a variety of vehicle models, and simplifying retrofitting processes. These embodiments collectively offer a versatile and adaptable solution that integrates advanced technologies into a compact and efficient design.

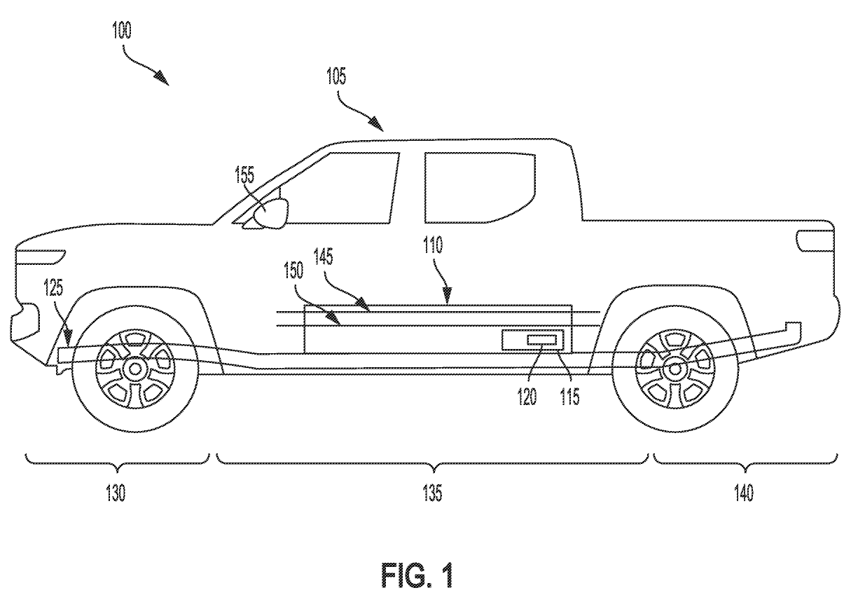

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105.

The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

The vehicle 105 can include at least one mirror or mirror assembly. For example, as shown in FIG. 1, the vehicle 105 includes a mirror assembly 155. The mirror assembly 155 can refer to or include at least one of an assembly, a housing, a module, a component, among other discrete structural elements. The mirror assembly 155 can include at least one reflective surface such that objects or an area adjacent to the vehicle 105 are visible. The mirror assembly 155 can be coupled with or otherwise attached to the vehicle 105. For example, the mirror assembly 155 can include a frame which is coupled, via one or more fasteners to a body of the vehicle 105.

The mirror assembly 155 can include one or more structural components to support a reflect surface (e.g., a mirror). The mirror assembly 155 can facilitate rear visibility or side visibility for an operator (e.g., driver) of the vehicle 105. The mirror assembly 155 can include sensors, cameras, lights, or other components to facilitate various features of the vehicle 105. For example, the mirror assembly 155 can include a camera to facilitate an autonomous driving mode for the vehicle 105. As another example, the mirror assembly 155 can include lights to provide directional indicators (e.g., blinkers, turn signals, etc.).

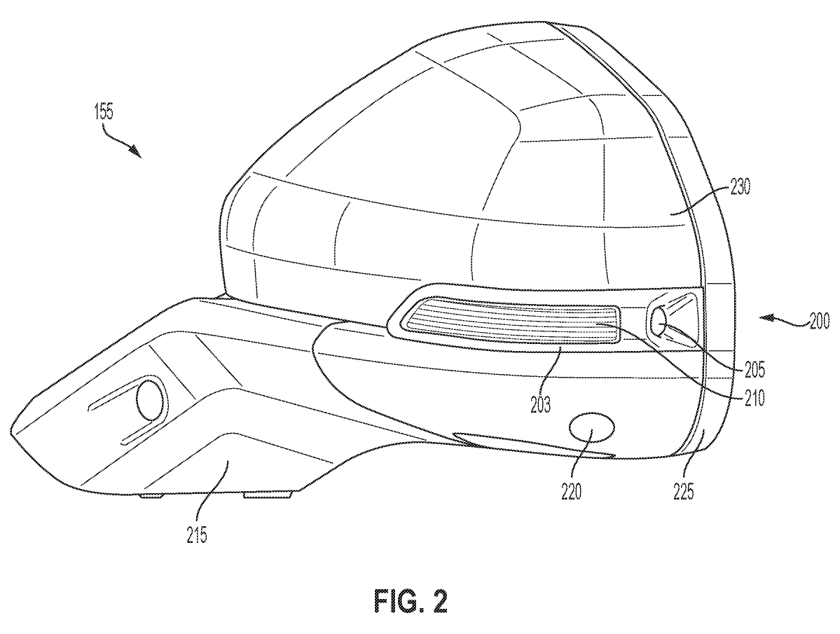

FIG. 2 depicts a perspective view of the mirror assembly 155, in accordance with some aspects. The mirror assembly 155 can provide or implement a structural enclosure for at least one sub-assembly 200. For example, the mirror assembly 155 can provide, via a housing 230, an enclosure to receive the sub-assembly 200 or one or more portions thereof. The housing 230 can define a shape for the mirror assembly 155. For example, the housing 230 can establish a form factor or other possible dimension or appearance for the mirror assembly 155. As another example, the housing 230 can define an overall view or appearance of the mirror assembly 155.

The sub-assembly 200 can be disposed within the housing 230. For example, the sub-assembly 200 can be at least partially disposed withing the housing 230. Stated otherwise, one or more portions, segments, or sections of the sub-assembly 200 can be located within the housing 230. At a portion of the sub-assembly 200 can be visible or discernable external to the housing 230. For example, the sub-assembly 200 can be identifiable or distinguishable from one or more components of the housing 230 or the mirror assembly 155.

The sub-assembly 200 can include at least one component, device, module, or sub-assembly. For example, as shown in FIG. 2, the sub-assembly 200 includes at least one light source 210 and at least one camera 205. The devices of the sub-assembly 200 can refer to or include at least one device described herein. For example, the camera 205 can refer to at least one camera described herein.

The light source 210 can produce, provide, or otherwise facilitate the emission of light. For example, the light source 210 can produce light via one or more light emitting diodes (LEDs). As another example, the light source 210 can emit photons to produce light. The light source 210 can indicate a status of one or more aspects of the vehicle 105. For example, the light source 210 can produce light to indicate a status of a directional (e.g., a blinker, a turn signal, flashers, etc.) for the vehicle 105. Stated otherwise, the light source 210 can produce light to indicate an intended direction or turn sequence for the vehicle 105.

The camera 205 can capture, obtain, collect, or otherwise gather at least one of video data or image data. For example, the camera 205 can collect image frames within a field of view of the camera 205. The camera 205 can collect data (e.g., video data, image data, etc.) to assist with autonomous control of the vehicle 105. For example, the camera 205 can collect data to provide for lane monitoring control of the vehicle 105. As another example, the camera 205 can collect data for object detection or vehicle control.

The sub-assembly 200 can include at least one portion. For example, as shown in FIG. 2, the sub-assembly 200 includes a portion 203. The portion 203 can refer to or include a first portion of the sub-assembly 200. The portion 203 can be positioned or otherwise located external to the housing 230. For example, as shown in FIG. 2, the portion 203 is located outside of the housing 230 such that the portion 203 is visible external to the housing 230. The portion 203 can receive one or more components of the sub-assembly 200. For example, as shown in FIG. 2, the portion 203 receives the light source 210 and the camera 205. Stated otherwise, the portion 203 can provide at least one of a surface or receptable for which the camera 205 and the light source 210 can be located or otherwise positioned.

The mirror assembly 155 can include one or more of modules, components, and/or sub-assemblies that are discrete from the sub-assembly 200. For example, the mirror assembly 155 can include at least one sub-assembly that is discernable or distinguishable from the sub-assembly 200. As shown in FIG. 2, the mirror assembly 155 includes a mirror 225, a frame (shown as mounting base 215), and a second camera 220. The mounting base 215 can couple the mirror assembly 155 to the vehicle 105. For example, the mounting base 215 can include one or more of slots, apertures, or openings for which one or more fasteners can couple or otherwise secure the mirror assembly to the vehicle 105. The second camera 220 can collect data to provide at least a portion of a field of view. For example, the second camera 220 can collect data which provides at least a portion of a bird’s eye or 360 degree field of view with respect to the vehicle 105.

The sub-assembly 200 can replace at least one sub-assembly. For example, the mirror assembly 155 can be initially packaged or assembled with a sub-assembly that includes a blinker. The sub-assembly 200 can be packaged or otherwise arranged such that the sub-assembly 200 can be situated or otherwise positioned in an area of the mirror assembly 155 that previously housed the blinker. As another example, the sub-assembly 200 can include a standard form factor such that the sub-assembly 200 can occupy at least a portion of the housing 230 which was previously occupied by the blinker. Stated otherwise, the sub-assembly 200 can fit within the housing 230 or the mirror assembly 155 by occupying an area or portion of the mirror assembly 155 that was previously occupied with an Original Equipment Manufacturer (OEM) part or sub-assembly.

The camera 205 and the light source 210 can be integratable with the mirror assembly 155. For example, the sub-assembly 200 (e.g., the camera 205, the light source 210, etc.) can integrate or communicate with the mirror assembly 155 or one or more components thereof based on the mirror assembly 155 including or communicating with one or more processing circuits that process information produced by at least one second light source or at least one second camera. Stated otherwise, responsive to the mirror assembly 155 including or communicating with one or more processing circuits that process information for light sources or cameras, the sub-assembly 200 can integrate with the mirror assembly 155. As another example, the vehicle 105 can include one or more processing circuits that process information or otherwise communication with at least one second light source and at least one second camera. In this example, the sub-assembly 200 can integrate with the mirror assembly 155 given that the vehicle 105 includes hardware to process information from the camera 205 or the light source 210.

The light source 210 and the camera 205 can include one or more separate or discreate locations relative to one another. For example, the light source 210 can have a first location on the sub-assembly 200. As another example, the camera 205 can have a second location on the sub-assembly 200 that is different than the location of the light source 210. At least one of the location of the light source 210 or the location of the camera 205 can be selected to account for a field of view of the camera 205. For example, the camera 205 can be offset or at least partially separate from the light source 210. Stated otherwise, the location of the camera 205 is selected based on a location of the light source 210. Additionally or alternatively, the location of the light source 210 is selected such that light produced by the light source 210 is visible external to the vehicle 105. For example, the location of the light source 210, on the sub-assembly 200, is selected such that the light produced by the light source 210 is visible from outside of the vehicle 105. As another example, the location of the light source 210, on the sub-assembly 200, is selected such that the field of view (of the camera 205) is unobstructed by the light produced by the light source 210. Stated otherwise, the production of light (by the light source 210) does not result in the light reaching or otherwise being within view of the camera 205.

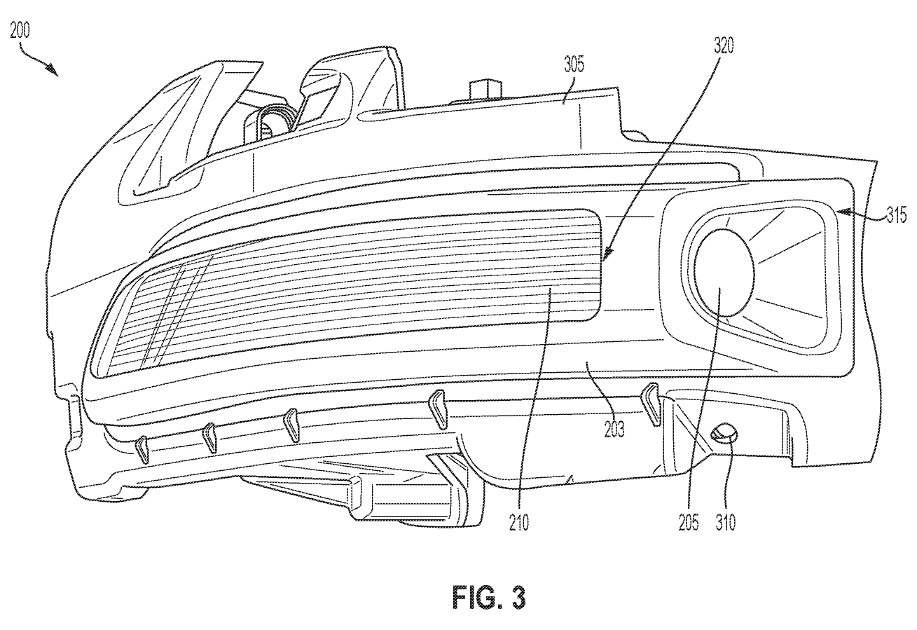

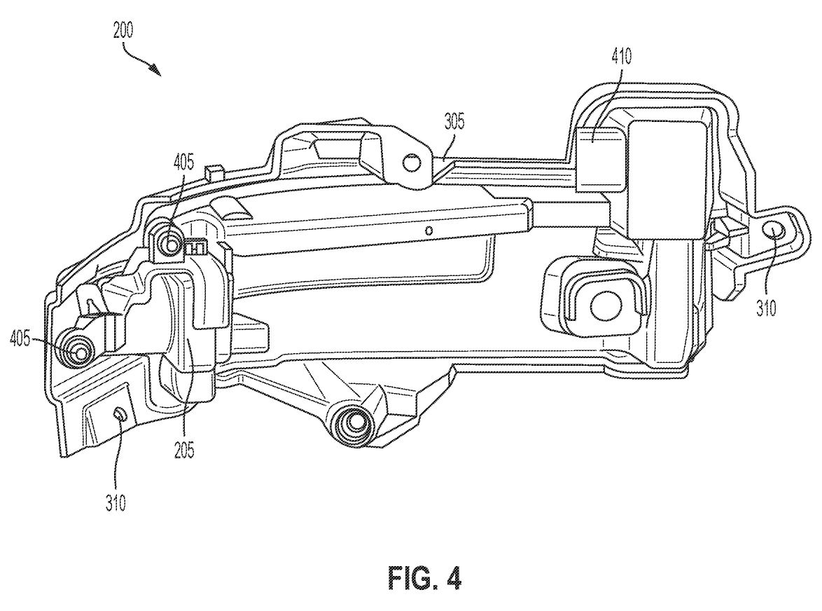

FIGS. 3-4 depict perspective views of the sub-assembly 200, in accordance with some aspects. The sub-assembly 200 can include a body 305. The body 305 can provide or otherwise define a shape or structure for the sub-assembly 200. The body 305 can include or otherwise house one or more components of the sub-assembly 200. The sub-assembly 200 can integrate the light source 210 and the camera 205 on the body 305. For example, the portion 203 (which includes the camera 205 and the light source 210) can be packaged or otherwise arranged such that the camera 205 and the light source 210 are provided with one another. Stated otherwise, the portion 203 can be discrete or separate from the body 305 such that the camera 205 and the light source 210 can be added to the body 305. Additionally or alternatively, the light source 210 and the camera 205 can be packaged with one another responsive to adding or otherwise including the light source 210 and the camera 205 on the portion 203.

The sub-assembly 200 can include at least one portion 310. The portion 310 can be separate or discrete from at least one additional portion of the sub-assembly 200. For example, the portion 310 can be separate from the portion 203. The portion 310 can removably couple with the housing 230. For example, the portion 310 can include one or more apertures or openings to receive fasteners to couple with the housing 230. Stated otherwise, the portion 310 can be secured to the housing 230 via one or more fasteners. Moreover, the portion 310 can be removable from the housing 230 responsive to removal of the fasteners. The portion 310 can be positioned at least partially within the housing 230. For example, the portion 310 can be situated within the housing 230 responsive to assembling or otherwise arranging the mirror assembly 155 similar to that shown in FIG. 2. As another example, the portion 310 can be enclosed by the housing 230 responsive to the assembly of the mirror assembly 155.

The sub-assembly 200 can include at least one segment or section. For example, as shown in FIG. 3, the sub-assembly 200 includes a first segment 315 and a second segment 320. The camera 205 can be disposed on the first segment 315. For example, the camera 205 can be located on or otherwise secured to the first segment 315 such that the first segment 315 includes the camera 205. The light source 210 can be disposed on the second segment 320. For example, the second segment 320 can provide a surface or an area to receive the light source 210. The first segment 315 can be located lateral to one or more components, segments, sections, or portions of the sub-assembly 200. For example, as shown in FIG. 3, the first segment 315 is lateral to the second segment 320. As another example, the first segment 315 can be located lateral to the cabin of the vehicle 105. Stated otherwise, the second segment 320 can be positioned between a middle portion of the vehicle 105 and the first segment 315 such that the second segment 320 is closer (relative to the first segment 315) to the middle portion of the vehicle 105.

The perspective view, as shown in FIG. 3, of the sub-assembly 200 can refer to or include a front view. For example, the sub-assembly 200, as shown in FIG. 3, provides a depiction of the sub-assembly 200 as if the sub-assembly 200 were removed from the mirror assembly 155 depicted in FIG. 2. The perspective view, as shown in FIG. 4, of the sub-assembly 200 can refer to or include a rear view. For example, the sub-assembly 200, as shown in FIG. 4, provides a depiction of the sub-assembly 200 rotated approximately by 180 degrees relative to the perspective view of the sub-assembly 200 in FIG. 3.

As shown in FIG. 4, the camera 205 can be coupled with the body 305 via one or more fasteners 405. For example, the camera 205 or a sub-housing that includes the camera 205 can include at least one aperture for which the fasteners 405 can couple the camera 205 with the body 305. The sub-assembly 200 can include at least one connector 410. The connector 410 can communicably couple the sub-assembly 200 with at least one component of the vehicle 105. For example, the connector 410 can couple the sub-assembly 200 with a Controller Area Network (CAN) bus of the vehicle 105.

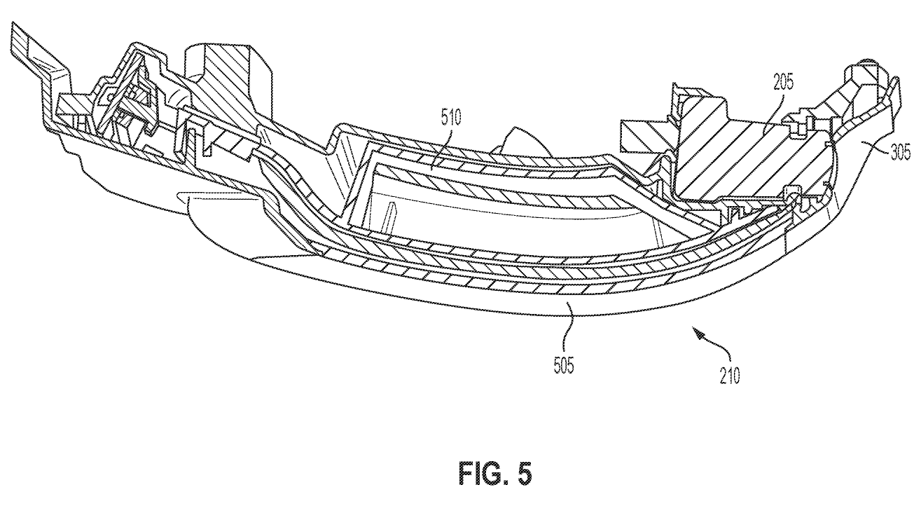

FIG. 5 depicts a cross-sectional view of the sub-assembly 200, in accordance with some aspects. The light source 210 can include at least one cover 505 and at least one light element 510. The cover 505 can include at least one of a shield, an enclosure, or a structure to isolate the light element 510 from an external environment. For example, the cover 505 can provide a surface between the light element 510 and the external environment. The light element 510 can include at least one of one or more Light Emitting Diodes (LEDs), halogen bulbs, incandescent lights, or among other possible structures or components that can produce light.

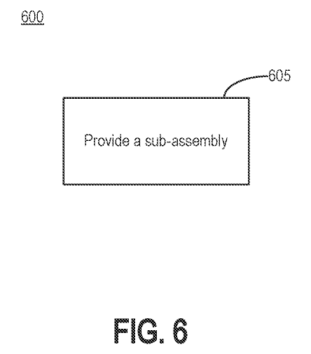

FIG. 6 depicts a flow diagram of a process 600, in accordance with some aspects. The process 600 can include manufacturing, providing, packaging, or otherwise making available at least one component described herein. For example, the process 600 can include the packaging of the mirror assembly 155. As another example, the process 600 can include the packaging of the sub-assembly 200.

At act 605, a sub-assembly can be provided. For example, a sub-assembly that includes the camera 205 and the light source 210 can be provided. The sub-assembly can be provided by at least one of coupling, securing, attaching, or otherwise mounting the sub-assembly to a mirror assembly of a vehicle. For example, the sub-assembly can be removably coupled with the housing 230 during the manufacturing or assembling of the mirror assembly 155. As another example, the sub-assembly can be retrofitted to mirror assembly 155. Stated otherwise, the sub-assembly can be added to or otherwise integrated with the mirror assembly subsequent to the assembly or packaging of the mirror assembly 155.

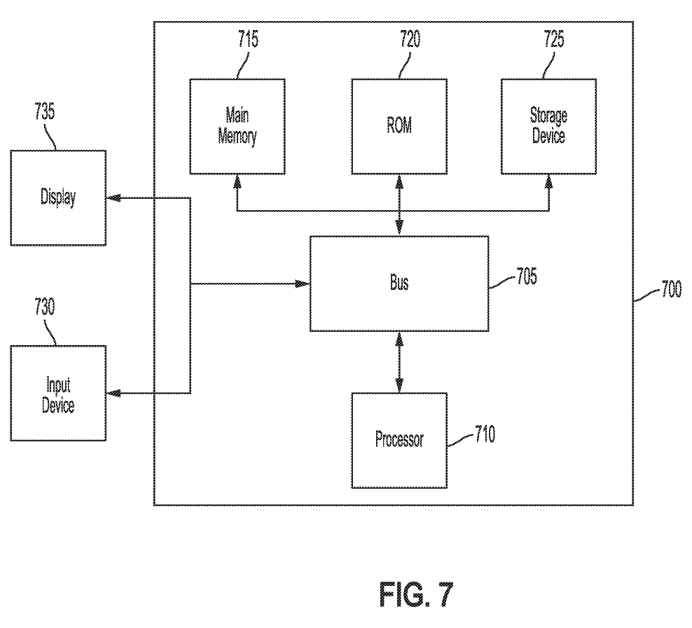

FIG. 7 depicts an example block diagram of an example computer system 700. The computer system or computing device 700 can include or be used to implement a data processing system or its components. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be used for storing information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions.

The computing system 700 may be coupled via the bus 705 to a display 735, such as a liquid crystal display, or active matrix display, for displaying information to a user such as a driver of the electric vehicle 105 or other end user. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component,” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical, or other positioning or orientation descriptions include variations within +/-10% or +/-10 degrees of pure vertical, parallel, or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An assembly for a vehicle, the assembly comprising:
a housing to define a shape of the assembly;
a sub-assembly to at least partially dispose within the housing; and
the sub-assembly, including:
a light source to indicate a status of a directional for the vehicle; and
a camera to assist with autonomous control of the vehicle.

2. The assembly of claim 1, comprising:
the sub-assembly, including:
a first portion to:
position external to the housing; and
receive the light source and the camera; and
a second portion to:
removably couple with the housing; and
position at least partially within the housing.

3. The assembly of claim 1, comprising:
the camera to dispose on a first segment of the sub-assembly;
the light source to dispose on a second segment of the sub-assembly; and
the first segment of the sub-assembly located lateral to both (i) the second segment of the sub-assembly and (ii) a cabin of the vehicle.

4. The assembly of claim 1, comprising:
one or more second sub-assemblies that are discrete from the sub-assembly; and
the one or more second sub-assemblies including at least one of:
a mirror;
a frame to couple the assembly with the vehicle; or
a second camera to provide at least a portion of a field of view with respect to the vehicle.

5. The assembly of claim 1, comprising:
the sub-assembly configured to:
replace at least one sub-assembly previously included with the assembly; and
occupy at least a portion of the housing for which the at least one sub-assembly previously occupied.

6. The assembly of claim 1, comprising:
the light source having a first location on the sub-assembly;
the camera having a second location on the sub-assembly;
the second location selected such that the camera includes a field of view; and
the first location selected such that (i) light produced by the light source is visible external to the vehicle and (ii) the field of view is unobstructed by the light produced by the light source.

7. The assembly of claim 1, comprising:
the sub-assembly configured to:
integrate the light source and the camera on a body of the sub-assembly such that the light source and the camera are packaged with one another.

8. The assembly of claim 1, comprising:
the light source and the camera both integratable with the assembly responsive to the vehicle including one or more processing circuits that are configured to communicate with at least one second light source or at least one second camera.

9. A vehicle, comprising:
an assembly, comprising:
a housing to define a shape of the assembly;
a sub-assembly configured to at least partially dispose within the housing; and
the sub-assembly, including:
a light source configured to indicate a status of a directional for the vehicle; and
a camera configured to assist with autonomous control of the vehicle.

10. The vehicle of claim 9, comprising:
the sub-assembly, including:
a first portion to:
position external to the housing; and
receive the light source and the camera; and
a second portion to:
removably couple with the housing; and
position at least partially within the housing.

11. The vehicle of claim 9, comprising:
the camera to dispose on a first segment of the sub-assembly;
the light source to dispose on a second segment of the sub-assembly; and
the first segment of the sub-assembly located lateral to both (i) the second segment of the sub-assembly and (ii) a cabin of the vehicle.

12. The vehicle of claim 9, comprising:
one or more second sub-assemblies that are discrete from the sub-assembly; and
the one or more second sub-assemblies including at least one of:
a mirror;
a frame to couple the assembly with the vehicle; or
a second camera to provide at least a portion of a field of view with respect to the vehicle.

13. The vehicle of claim 9, comprising:
the sub-assembly configured to:
replace at least one sub-assembly previously included with the assembly; and
occupy at least a portion of the housing for which the at least one sub-assembly previously occupied.

14. The vehicle of claim 9, comprising:
the light source having a first location on the sub-assembly;
the camera having a second location on the sub-assembly;
the second location selected such that the camera includes a field of view; and
the first location selected such that (i) light produced by the light source is visible external to the vehicle and (ii) the field of view is unobstructed by the light produced by the light source.

15. The vehicle of claim 9, comprising:
the sub-assembly configured to:
integrate the light source and the camera on a body of the sub-assembly such that the light source and the camera are packaged with one another.

16. The vehicle of claim 9, comprising:
the light source and the camera both integratable with the assembly responsive to the vehicle including one or more processing circuits that are configured to communicate with at least one second light source or at least one second camera.

17. A sub-assembly for integration with an assembly, the sub-assembly configured to at least partially dispose within a housing of the assembly, and the sub-assembly comprising:
a light source packaged with a camera;
the light source configured to indicate a status of a directional for a vehicle; and
the camera configured to assist with autonomous control of the vehicle.

18. The sub-assembly of claim 17, comprising:
the camera to dispose on a first segment of the sub-assembly;
the light source to dispose on a second segment of the sub-assembly; and
the first segment of the sub-assembly located lateral to both (i) the second segment of the sub-assembly and (ii) a cabin of the vehicle.

19. The sub-assembly of claim 17, wherein the assembly further includes:
one or more second sub-assemblies that are discrete from the sub-assembly; and
the one or more second sub-assemblies including at least one of:
a mirror;
a frame to couple the assembly with the vehicle; or
a second camera to provide at least a portion of a field of view with respect to the vehicle.

20. The sub-assembly of claim 17, comprising:
the light source and the camera both integratable with the assembly responsive to the vehicle including one or more processing circuits that are configured to communicate with at least one second light source or at least one second camera.
